(19) United States
(12) Patent Application Publication
(10) Pub. No.: US 2013/0027194 A1
(43) Pub. Date: Jan. 31, 2013

(54) REMOTE CONTROLLER, ELECTRONIC APPARATUS HAVING THE SAME, AND METHOD OF DRIVING THE SAME

(71) Applicant: Bomin WENG, New Taipei City (TW)

(72) Inventor: Bomin WENG, New Taipei City (TW)

(21) Appl. No.: 13/276,051

(22) Filed: Oct. 18, 2011

(30) Foreign Application Priority Data
Jul. 25, 2011 (TW) 100126237

(51) Int. Cl. G05B 11/01

(52) U.S. Cl. 340/12.54; 340/12.22

(57) ABSTRACT

This invention provides remote control devices, electronic apparatuses, and their controlling methods. In an embodiment, a remote control device having buttons is used to control an electronic apparatus having a screen, and the user employs the buttons and the screen to disable one or more of the buttons.

### CROSS REFERENCE TO RELATED APPLICATIONS

The entire contents of Taiwan Patent Application No. 100126237, filed on Jul. 25, 2011, from which this application claims priority, are incorporated herein by reference.

### BACKGROUND OF THE INVENTION

1. Field of the Invention

The present invention relates to remote controllers, electronic apparatuses, and their driving method for increasing the convenience to users.

2. Description of Related Art

A remote controller is a component of an electronic apparatus, used for operating the apparatus wirelessly within a short distance. As the functions of the apparatuses are being increased, the remote controllers are getting complicated. However, elders and children may suffer from the complicated controllers.

For example, a television may be used to play games, play digital video discs (DVDs), access internets, review images, and so on, except for receiving cable or wireless television signals. Typically, a remote controller has one or more keys or buttons used for switching these functions; however, the remote controller may be too complicated to operate for elders.

### SUMMARY OF THE INVENTION

An object of this invention is to provide remote controllers, electronic apparatuses, and their control methods for increasing the convenience to users.

Accordingly, an embodiment of this invention provides a method for controlling a remote controller, wherein the remote controller comprises a plurality of control components for remote controlling an electronic apparatus, the electronic apparatus comprises or connects with a screen, and the method comprises the steps of: emitting an easy remote control command; receiving the easy remote control command and displaying the easy remote control command on the screen; determining whether to enter a easy remote control mode; and in responsive to the easy remote control mode being entered, determining which control components to be disabled.

Accordingly, another embodiment of this invention provides a remote controller, comprising a plurality of control components used to control an electronic apparatus, the electronic apparatus comprising or connecting with a screen, the remote controller further comprising: means for emitting an easy remote control command, such that the electronic apparatus receives the easy remote control command and display it on the screen; means for determining whether to enter an easy remote control mode; and means for determining which control components to be disabled, in responsive to the easy remote control mode being entered.

Accordingly, another embodiment of this invention provides an electronic apparatus, comprising a remote controller, a receiver, a memory, and a controller. The remote controller comprises a plurality of control components and a transmitter, wherein each control component and each combination of the control components refers to a code, and the transmitter emits a signal involving one of the codes. The receiver is used for receiving the signal. The memory stores a plurality of programs, and each program corresponding one of the codes. The controller performs the program corresponding to the code involved in the signal. The user can determine whether the controller ignores the signal when receiving the signal.

Accordingly, another embodiment of this invention provides a remote controller that comprises a plurality of control components used to control an electronic apparatus, wherein the remote controller further comprises at least a special key, when the special key is pressed, some of the control components will be disabled.

### BRIEF DESCRIPTION OF THE DRAWINGS

FIG. 1 is a flow chart showing a control method according to an embodiment of this invention.

FIG. 2 and FIG. 3 show a remote controller used to control an electronic apparatus, according to an embodiment of this invention.

FIGS. 4A-4D show one embodiment of this invention to emit the easy remote control command and display it on the screen.

FIGS. 5A-5C show one embodiment of this invention to set the remote controller.

FIG. 6 is a block diagram of the remote controller and the electronic apparatus shown in FIG. 2 and FIG. 3.

FIG. 7 shows a remote controller according to another embodiment of this invention.

### DESCRIPTION OF THE PREFERRED EMBODIMENT

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known components and process operations are not been described in detail in order not to unnecessarily obscure the present invention. While drawings are illustrated in details, it is appreciated that the quantity of the disclosed components may be greater or less than that disclosed, except expressly restricting the amount of the components.

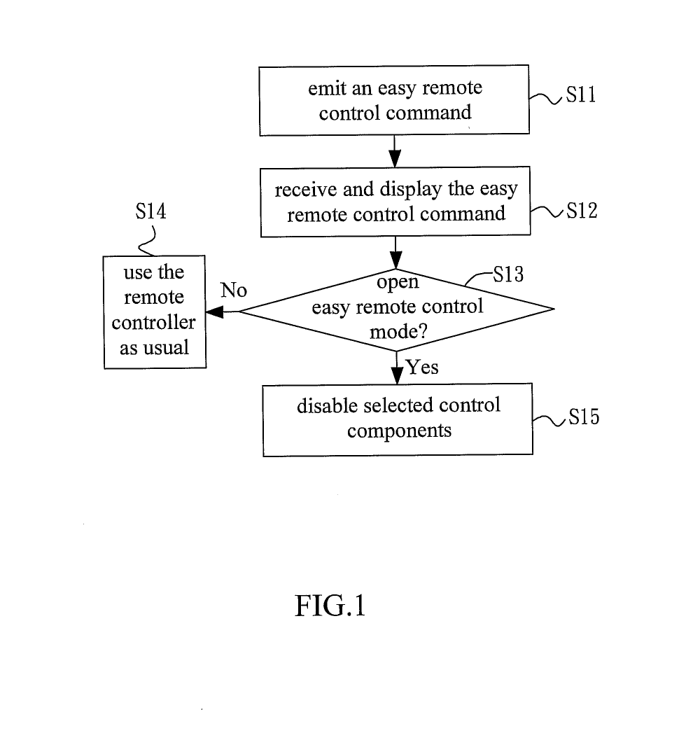

FIG. 1 is a flow chart showing a control method according to an embodiment of this invention. The method is used for controlling a remote controller consisted of control components. The remote controller is used for controlling an electronic apparatus that comprises or connects with a screen, such as a screen of a display, or a screen projected from a projector. The control components typically may comprise keys or buttons, and may also comprise one or more track balls or jog balls, one or more mice, one or more touch screens, one or more control rods, and the like. The electronic apparatus may include, but is not limited to, a television, or a digital video disc (DVD) player.

Referring to FIG. 1, the method comprises the following steps. Step 11, an easy remote control command is emitted. The remote controller, preferably, emits the command, or, the electronic apparatus, alternatively, emits the command. Step 12, the electronic apparatus receives the easy remote control command and displays it on the screen. Step 13, the user determines whether an easy remote control mode is opened or not. Step 14, if the user disapproves to open the easy remote control mode, all the control components (such as keys) are used as usual, i.e. enabled, and the remote controller is at a normal operation mode. Step 15, if the easy remote control mode is determined to open, the user selects one or more of the control components to be disabled.

The following exemplary example illustrates a remote controller, an electronic apparatus, and their control method of this invention.

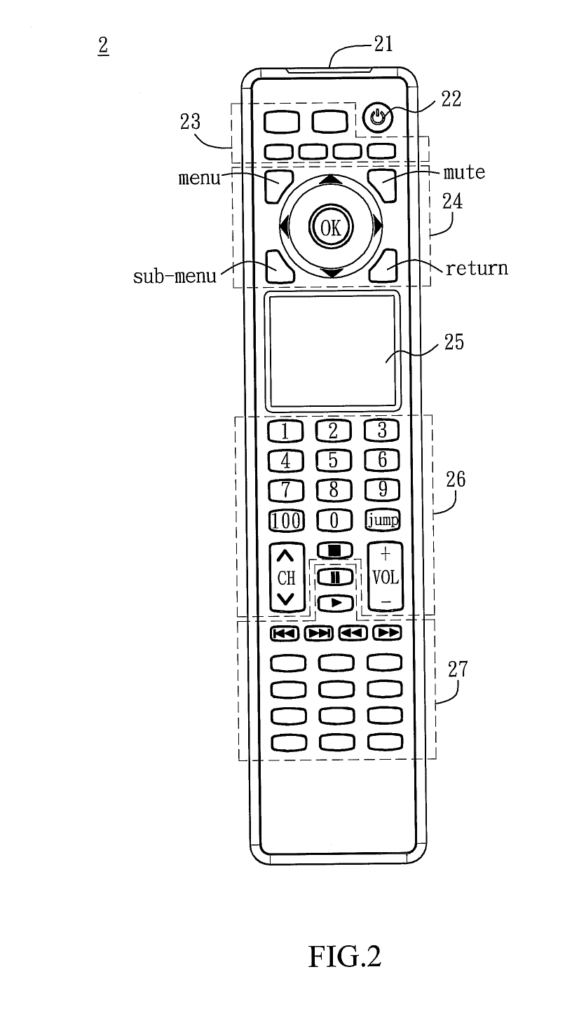

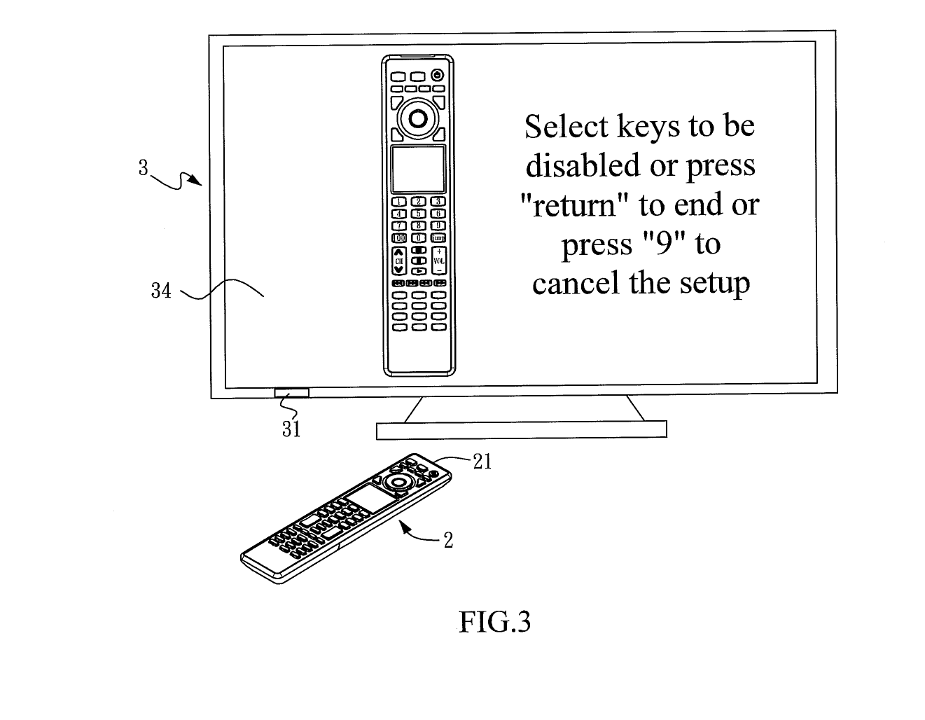

FIG. 2 and FIG. 3 show a remote controller 2 according to an embodiment of this invention. The remote controller 2 is used to control an electronic apparatus 3, preferably a television 3. Referring to FIG. 2, in this example, the remote controller 2 comprises control components including a transmitter 21, a power key 22, a function unit 23, a setup unit 24, a touch unit 25, a base unit 26, and a related unit 27. The transmitter 21 emits a signal, such as an infrared signal. Each unit may consist of keys. The function unit 23 can switch the function of the television 3. The setup unit 24 comprises an OK key and direction keys, including upward, downward, leftward, and rightward keys, allowing the user to move a moveable pointer, such as a focus or a cursor on the screen. The user may employ the touch unit 25 to control the television 3 in a touch control manner. The base unit 26 comprises channel selection keys, volume control keys, number input keys, and so on.

Referring to FIG. 3, the remote controller 2 emits an easy remote control command via the transmitter 21, and the electronic apparatus 3 employs a receiver 31 to receive the command and display it on the screen 34. The remote controller 2 employs one or a combination of the control components, e.g., one or more keys of the units 23/24/26/27 or the touch unit 25, to emit the easy remote control command.

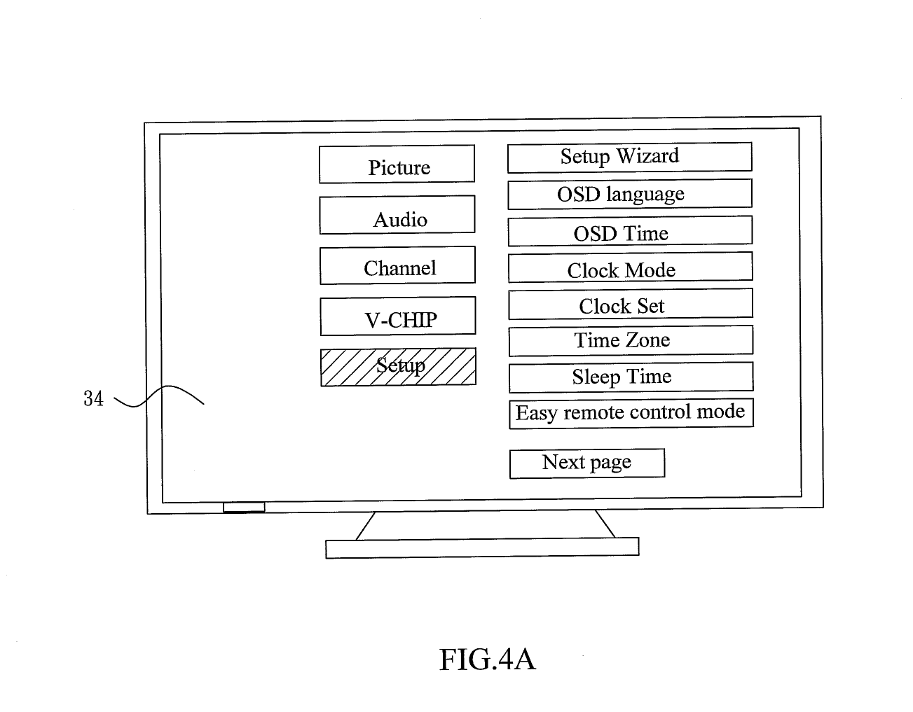

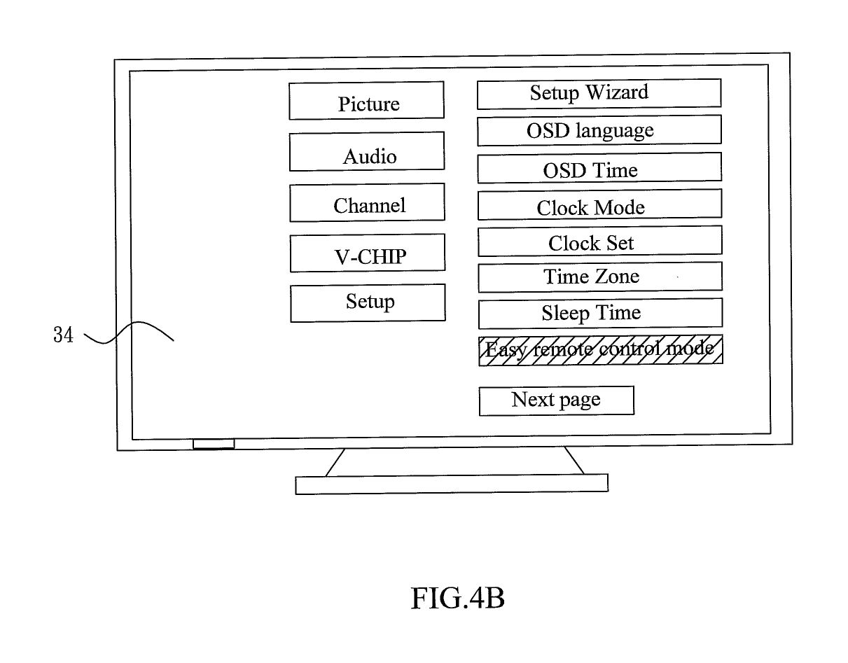

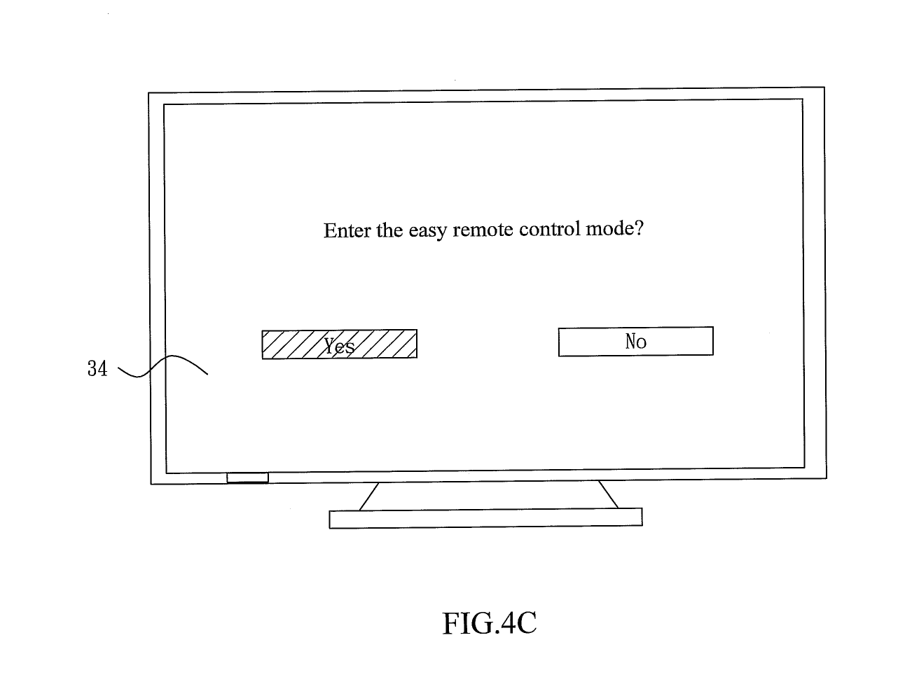

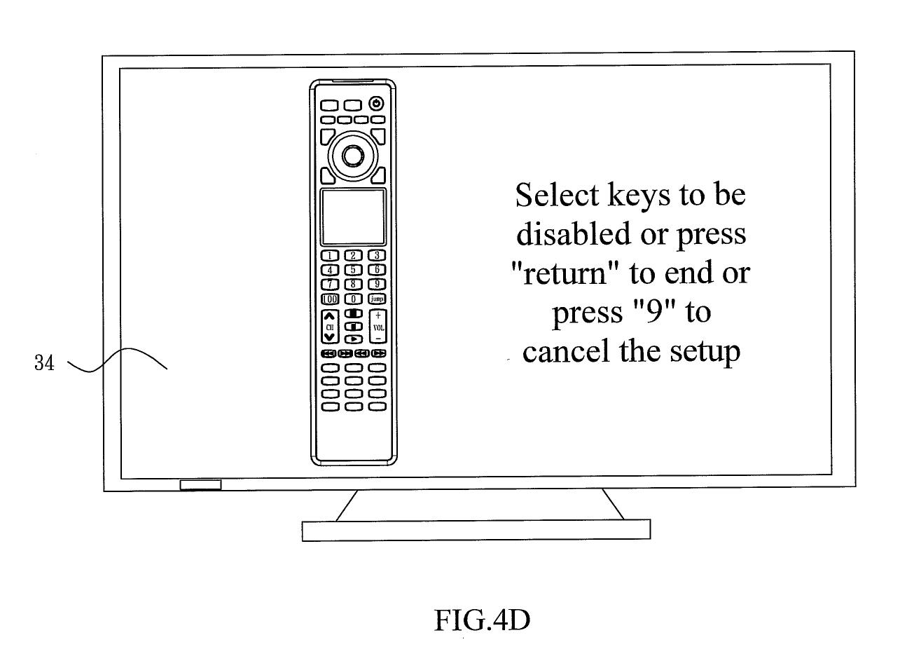

In practical, the remote controller 2 may use various ways to emit the easy remote control command and display it on the screen 34; FIGS. 4A-4D show one of them. Referring to FIG. 4A, when the user presses the “menu” key of the setup unit 24, a list consisted of options including “picture,” “audio,” “channel,” “V-CHIP,” and “setup” is displayed on the screen 34. The user employs the direction keys of the setup unit 24 to move the focus on the “setup” option. The user then presses the “OK” key, such that a sub-list consisted of options including “Setup Wizard,” “OSD Language,” “OSD Time,” “Clock Mode,” “Time Zone,” “Sleep Time,” “Easy Remote Control Mode,” and so on is additionally displayed on the screen 34. Referring to FIG. 4B, the user again employs the direction keys of the setup unit 24 to move the focus on the “Easy Remote Control Mode” option of the sub-list and press the “OK” key. A frame is hence displayed on the screen 34 as shown in FIG. 4C. If the user determines to open the easy remote control mode, he may move the focus on the “yes” option (the default option) then press the “OK” key, and a frame is displayed on the screen 34 as shown in FIG. 4D. If the user disapproves to enter the easy remote control mode, he may move the focus on the “no” option then press the “OK” key, then the screen 34 will return to the normal operation state. Notice that well-known means in the art may be used to increase or decrease the number of the steps in this embodiment.

In another embodiment of this invention, when the user presses a hot key, presses a specific key for a predetermined period (such as 3 seconds), or simultaneously presses two keys of the remote controller 2, the remote controller 2 will emit the easy remote control command via the transmitter 21, and the command is displayed on the screen 34, as shown in FIG. 3 or FIG. 4D.

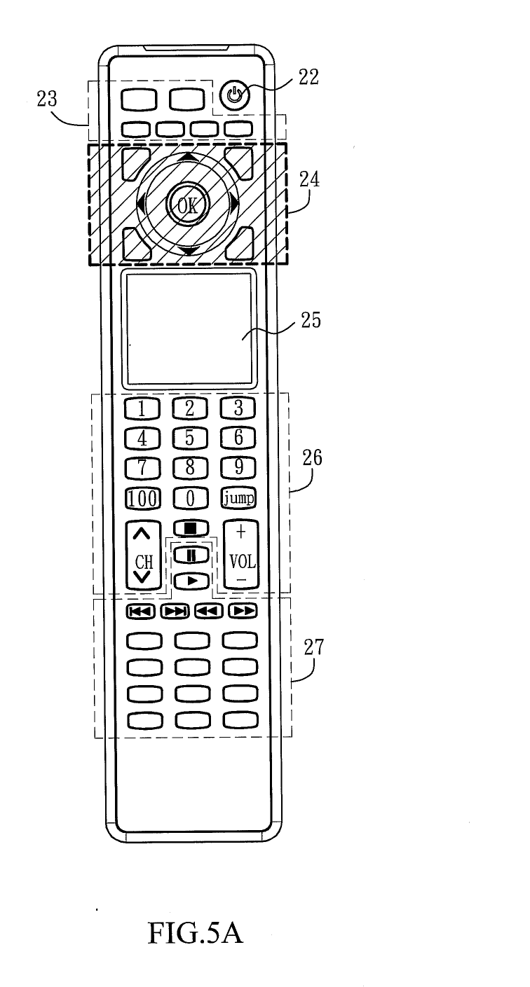

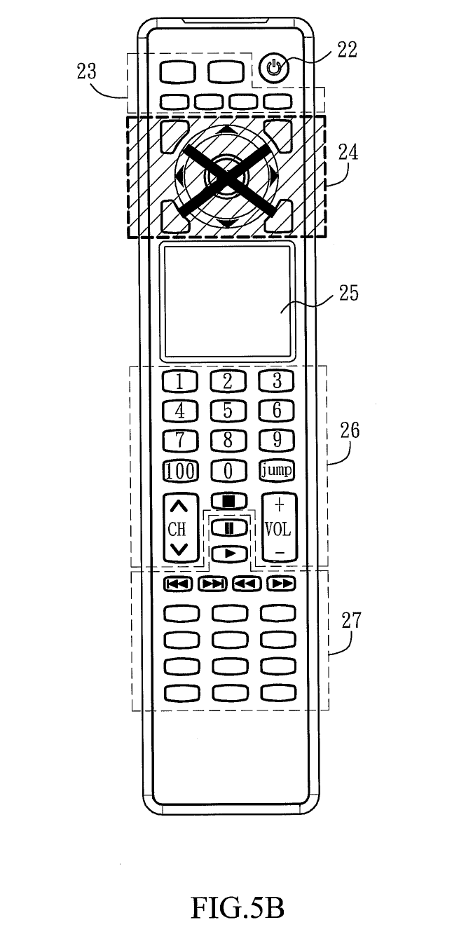

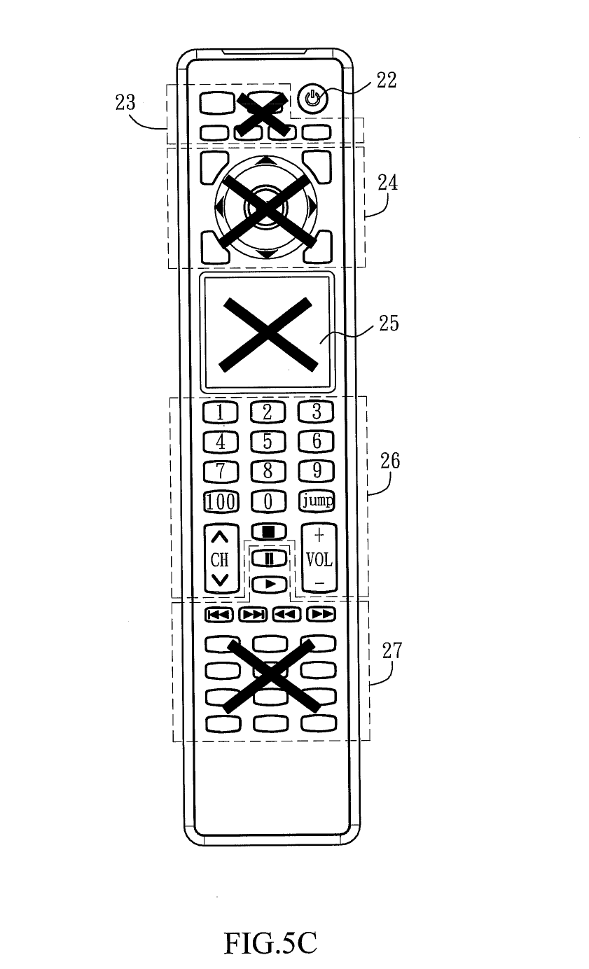

Referring to FIG. 5A, when the screen 34 shows the frame of FIG. 3 or FIG. 4D, and the easy remote control mode is entered, the user may use the direction keys of the setup unit 24 to move the focus on the keys or units that she or he wants to set, e.g., the setup unit 24 in this example.

Referring to FIG. 5B, when the user then presses the “OK” key, a cross symbol is displayed on the setup unit 24 indicating that the keys of which will be disabled after the operation is finished. The user may press the “OK” key again to cancel the cross symbol.

Referring to FIG. 5C, the user then may use the direction keys and “OK” key to set other keys or units. In this example, the user wants to enable the power key 22 and the base unit 26 and disable other units.

After the setup is finished, the user may use the direction keys and the “OK” key, or other keys or control components to confirm and leave the setup. After the user confirms and leaves the setup, the setup becomes effective. In a particular embodiment, a light source, such as a light-emitting diode, is arranged below each unit or key. The light sources below the enabled units or keys may be turned on after the setup becomes effective.

Notice that in this example the control components or keys are set in a “unit by unit” manner and each unit consists of many keys. Another embodiment may set the control components or keys in a “key by key” manner. According to another embodiment of this invention, the screen 34 may be a touch screen, and the user may employ the touch screen to emit the easy remote control command and perform the setup as shown in FIGS. 5A-5C.

Referring to FIG. 3 or FIG. 4D again, if the user disagrees to enter the easy remote control mode, she or he may press the “return” key to end the setup. In addition, the user may press the “9” key to cancel the current setup. In another embodiment of this invention, the user may employ one or more or a combination of the control components, or employ the touch screen, to cancel the current setup. In addition, the contents of the setup may be saved with a file name, and the user may access the saved file for revise or other uses.

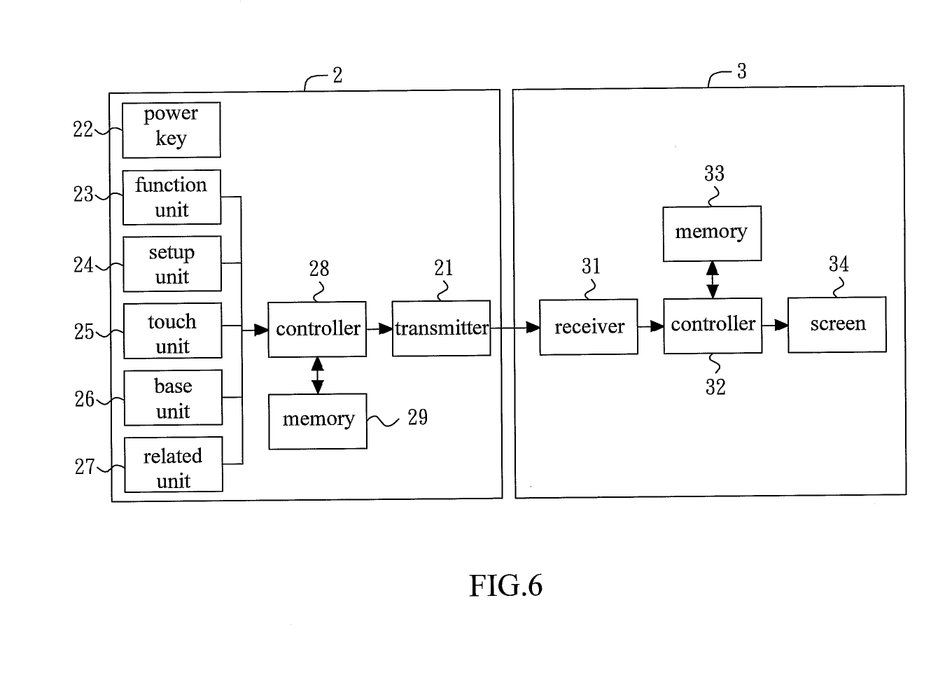

FIG. 6 is a block diagram of the remote controller 2 and the electronic apparatus 3 shown in FIG. 2 and FIG. 3. The remote controller 2 comprises a controller 28 and a memory 29, which stores many codes and each code indicates an action referring to a manipulated control component or a combination of the control components. For example, code “01” denotes that the “menu” key is pressed, code “02” denotes the “return” key is pressed, and code “03” denotes the “1” key and the “9” key are simultaneously pressed. When the user manipulates the control component of the remote controller 2, the transmitter 21 emits a signal including a code indicating which control component or control components are manipulated.

In addition, the electronic apparatus 3 comprises a controller 32 and a memory 33. The memory 33 stores many programs and each program corresponds to one of the codes. A receiver 31 receives a signal emitted from the transmitter 21 and transmits it to the controller 32, which will perform the program corresponding to the code involved in the signal.

In the foregoing embodiment, after the setup, all units will be disabled except the power key 22 and the base unit 26. After that, when the transmitter 21 emits a signal involving a code referring to a disabled control component, the controller 32 will ignore the signal; on the contrary, the controller 32 will perform the program corresponding to the code referring to one or more enabled control components.

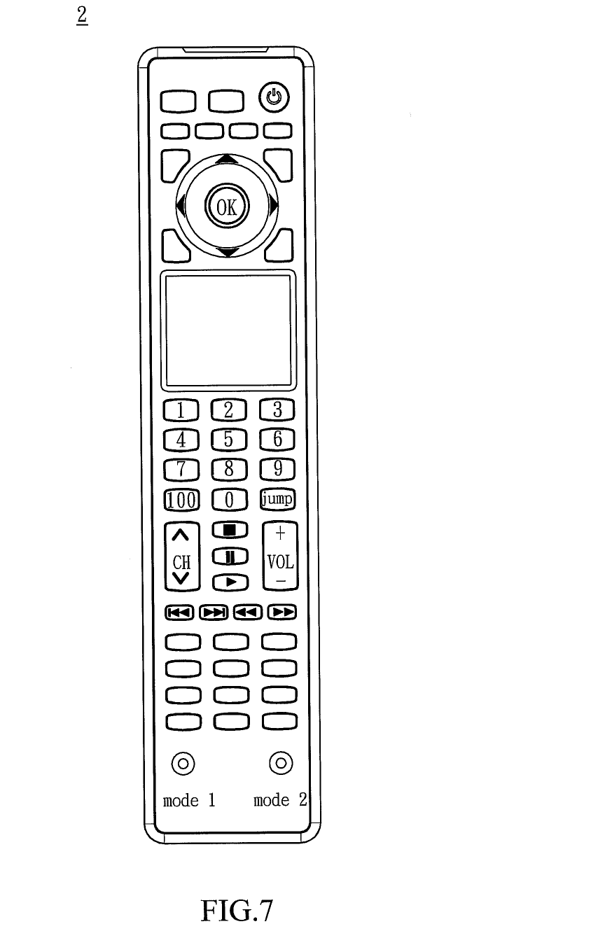

FIG. 7 shows a remote controller 2 used to control an electronic apparatus 3, according to another embodiment of this invention. This embodiment differs from the foregoing embodiments in that, the remote controller 2 comprises one or more special keys, such as “mode 1” and “mode 2” keys. Instead of using the screen 34, the user may press the special key (the hot key) to set which control components will be disabled. For illustrative purpose, when the “mode 1” key is pressed, only the number keys (“1,” “2,” “3” . . . ), the channel selection “CH” key, the volume control “VOL” key, and the power key remain enabled, and other keys or control components will be disabled. When the “mode 2” key is pressed, only the direction keys, the “OK” key, the power key, and the touch unit 25 remain enabled, and other keys or control components will be disabled. The setup of the “mode 1” may be suitable for the elders, and the setup of the “mode 2” may be suitable for playing games. In addition, the special keys may be a semi-hidden type and a tip is necessary to press them. In addition, a light source, such as a light-emitting diode, is arranged below each unit or key. The light sources below the enabled units or keys may be turned on after the setup becomes effective. In another embodiment of this invention, a specific key is pressed, or two or more specific keys of the remote controller 2 are simultaneously pressed to replace the special keys and perform the setup of mode 1 and mode 2.

Accordingly, the embodiment provides remote controllers, electronic apparatuses, and their control method, allowing the users to simplify the remote controller according to their individual needs, and thus increasing the convenience for the users, especially for elders and children.

Although specific embodiments have been illustrated and described, it will be appreciated by those skilled in the art that various modifications may be made without departing from the scope of the present invention, which is intended to be limited solely by the appended claims.

What is claimed is:

1. A method for controlling a remote controller, wherein the remote controller comprises a plurality of control components for remote controlling an electronic apparatus, the electronic apparatus comprises or connects with a screen, and the method comprises the steps of:
emitting an easy remote control command;
receiving the easy remote control command and displaying the easy remote control command on the screen;
determining whether to enter a easy remote control mode;
in responsive to the easy remote control mode being entered, determining which control components to be disabled.

2. The method as recited in claim 1, wherein the easy remote control command is emitted from the remote controller or the electronic apparatus.

3. The method as recited in claim 1, wherein the plurality of control component are selected from the group consisted of the following: one or more keys, one or more track balls or jog balls, one or more mice, one or more touch screens, one or more control rods, and combinations thereof.

4. A remote controller, comprising a plurality of control components used to control an electronic apparatus, the electronic apparatus comprising or connecting with a screen, the remote controller further comprising:
means for emitting an easy remote control command, such that the electronic apparatus receives the easy remote control command and display it on the screen;
means for operating whether to enter an easy remote control mode; and
means for operating which control components to be disabled, in responsive to the easy remote control mode being entered.

5. The remote controller as recited in claim 4, wherein the means for emitting an easy remote control command, the means for determining whether to enter an easy remote control mode, and the means for determining which control components to be disabled respectively comprise one or a combination of the plurality of control components.

6. The remote controller as recited in claim 4, wherein the plurality of control component are selected from the group consisted of the following: one or more keys, one or more track balls or jog balls, one or more mice, one or more touch screens, one or more control rods, and combinations thereof.

7. An electronic apparatus, comprising:
a remote controller comprising a plurality of control components and a transmitter, wherein each control component and each combination of the control components refers to a code, and the transmitter emits a signal involving one of the codes;
a receiver, for receiving the signal;
a memory, storing a plurality of programs, each program corresponding one of the codes; and
a controller, performing the program corresponding to the code involved in the signal;
wherein the controller can execute the user's determination including which control component to be disable or enable after receiving the signal.

8. The electronic apparatus as recited in claim 7, wherein the user employs the plurality of control components to determine which code or which codes to be ignored.

9. The electronic apparatus as recited in claim 8, wherein the plurality of control component comprises one or more of the following: one or more keys, one or more track balls or jog balls, one or more mice, one or more touch screens, one or more control rods, and combinations thereof.

10. The electronic apparatus as recited in claim 7, wherein the electronic apparatus further comprises or connects with a touch screen, and the user employs the touch screen to determine which code or which codes to be ignored.

11. A remote controller, comprising a plurality of control components used to control an electronic apparatus, wherein the remote controller further comprises at least a special key, when the special key is pressed, some of the control components will be disabled.

12. The remote controller as recited in claim 11, wherein the special key is a semi-hidden type of key, and a tip is used to press the special key.

13. The remote controller as recited in claim 11, wherein a light source is arranged below each control component, and the light sources below the non-disabled control components are turned on.
